(19) United States
(12) Patent Application Publication
(10) Pub. No.: US 2012/0327296 A1
(43) Pub. Date: Dec. 27, 2012

(54) CAMERA DEVICE FOR PORTABLE TERMINAL

(75) Inventor: Hyung-Joon KIM, Gyeonggi-do (KR)

(73) Assignee: SAMSUNG ELECTRONICS CO., LTD., Gyeonggi-Do (KR)

(21) Appl. No.: 13/242,308

(22) Filed: Sep. 23, 2011

(30) Foreign Application Priority Data
Jun. 24, 2011 (KR) 10-2011-0061661

(51) Int. Cl. H04N 5/225

(52) U.S. Cl. 348/373; 348/E05.024

(57) ABSTRACT

A camera device for a portable terminal includes: a photographing aperture formed on one surface of the housing of the portable terminal to provide a photographing path of a camera module housed in the housing; an adapter detachably provided on an outer face of the housing; and a reflector housed in the adapter, wherein the adapter is provided on the photographing aperture, and the reflector changes the photographing direction of the camera module.

### CLAIM OF PRIORITY

This application claims the priority under 35 U.S.C. §119(a) of an application entitled “Camera Device For Portable Terminal” filed in the Korean Intellectual Property Office on Jun. 24, 2011 and assigned Serial No. 10-2011-0061661, the contents of which are hereby incorporated by reference.

### BACKGROUND OF THE INVENTION

1. Field of the Invention

The present invention relates to a portable terminal, and more particularly to a portable terminal having an improved camera function for conveniently photographing or implementing augmented reality.

2. Description of the Related Art

Typically, a portable terminal allows a user to roam and conduct voice and data communication as well as Internet, mobile banking, multimedia file transmission, or an entertainment function, such as game or music or moving image reproduction, or the like. In the past, such a portable terminal was generally specialized to an individual specific function, such as a communication, a game function, a multimedia function, or an electronic organizer. Recently, due to the development of electric and electronic technologies, it has become possible to enjoy various other functions using a single mobile communication terminal.

Meanwhile, as portable terminals are equipped with an advanced camera device, portable terminals are encroaching on the compact digital camera market. In addition, the camera devices equipped in the portable terminals enable video communication beyond audio communication, and frequently are used for implementing augmented reality through a smart phone. The augmented reality is a technology for overlaying a virtual object or information on a user's view of the real world. A simple and representative example of using the augmented reality is when a camera device equipped in a portable terminal is aimed at a specific building or a store, various information items for the building or the store are output as a final picture together with the physical appearance of the subject.

A camera device for a conventional portable terminal typically includes a camera module installed opposite to a display device for photographing a subject, and a camera module installed parallel to the display device for video communication. However, there is an inconvenience in that in order to use the augmented reality, it is necessary for a user to manipulate the screen of the portable terminal while holding the portable terminal in such a manner that the camera module installed opposite to the display device is oriented toward the subject. Furthermore, since orienting the camera module toward a subject in a public place having a large floating population, such as a shopping mall or a subway station, in order to use the augmented reality function, may be misunderstood as an invasion of privacy by the surrounding people. Thus, there are limitations in using the augmented reality function depending on the environment of using the function.

### SUMMARY OF THE INVENTION

Accordingly, the present invention has been made to solve the above-mentioned problems occurring in the prior art and provides additional advantages, by providing a camera device for a portable terminal which allows an augmented reality function to freely be used regardless of the environment of using the camera device.

Also, the present invention provides a camera device for a portable terminal, which makes it convenient to operate the input device of the terminal while photographing a subject.

In accordance with an aspect of the present invention, a camera device for a portable terminal includes: a photographing aperture formed on one surface of the housing of the portable terminal to provide a photographing path of a camera module housed in the housing; an adapter detachably provided on an outer face of the housing; and a reflector housed in the adapter, wherein the adapter is provided on the photographing aperture, and the reflector changes the photographing direction of the camera module.

In accordance with an aspect of the present invention, a portable terminal, includes: a housing having a camera device provided therein, and an adapter provided on an outer face of the housing over the camera device and having a reflector disposed therein, the reflector is rotatable to change a photographing direction of the camera module, wherein the adaptor is pivotably coupled to the outer face of the housing and selectably pivots from a closed state from the housing.

In accordance with an aspect of the present invention, a portable terminal includes a housing having a camera device provided therein, and an adapter slidably attached to an outer face of the housing over the camera device, the adapter having a reflector that is rotatable to change a photographing direction of the camera module.

With the above-mentioned construction, the camera device for a portable terminal can change the photographing direction of the camera module through the reflector housed in the adapter. Therefore, it is not needed to necessarily direct the photographing direction of the camera module itself toward the subject. In other words, the user can conduct photographing in a desired direction in a state in which the user positions the terminal so that the user can view the display device of the terminal or can conveniently operate the touch screen function of the display device. As a result, there are advantages in that it is possible to alleviate limitations in using a augmented reality function, which are caused due to surrounding environments, and the camera device is convenient to use.

### BRIEF DESCRIPTION OF THE DRAWINGS

The above and other aspects, features and advantages of the present invention will be more apparent from the following detailed description taken in conjunction with the accompanying drawings, in which:

FIG. 1 is an exploded perspective view showing a portable terminal with a camera device in accordance with an embodiment of the present invention;

FIG. 2 is a perspective view showing a portable terminal having the camera device shown in FIG. 1;

FIG. 3 is a cross-sectional view showing a principal part of the camera device shown in FIG. 3; and

FIG. 4 is a perspective view showing a portable terminal having a camera device in accordance with another embodiment of the present invention.

### DETAILED DESCRIPTION OF THE PRESENT INVENTION

Hereinafter, embodiments of the present invention will be described with reference to the accompanying drawings. For the purposes of clarity and simplicity, a detailed description of known functions and configurations incorporated herein will be omitted as it may make the subject matter of the present invention rather unclear.

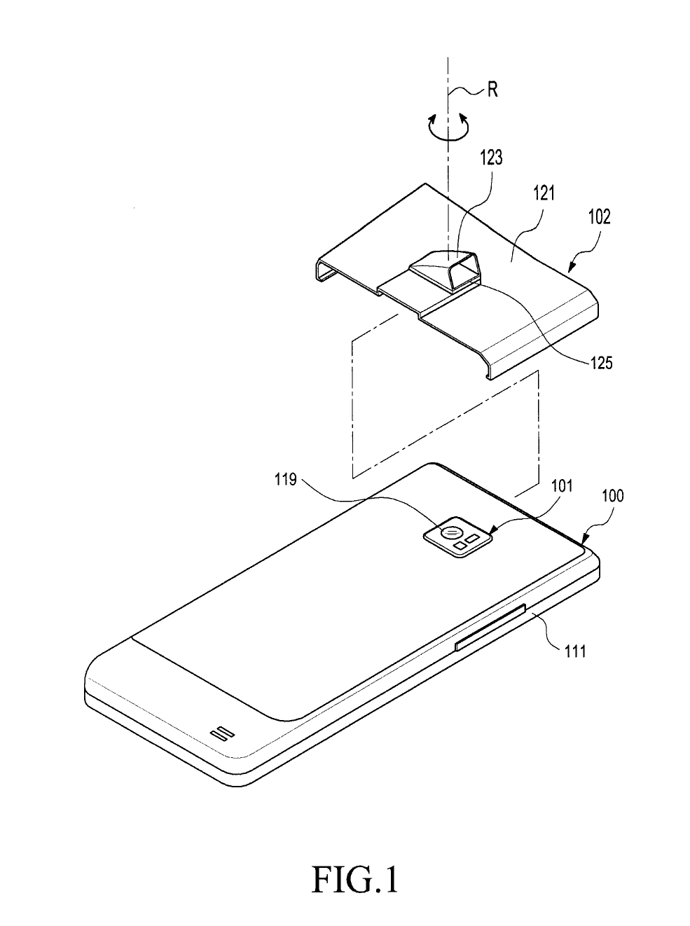

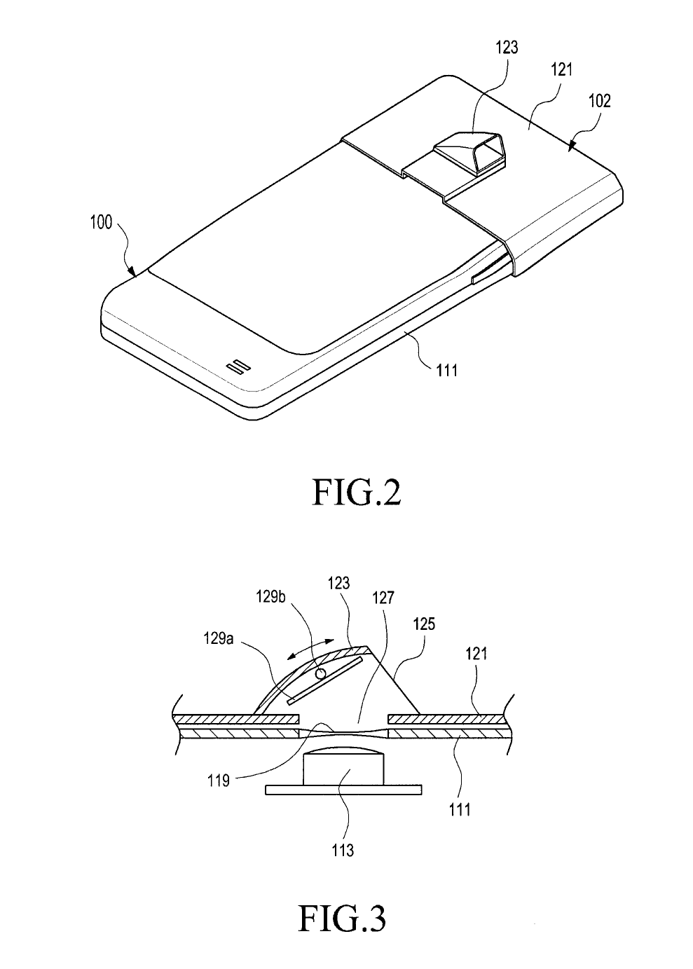

Referring to FIGS. 1 to 3, a camera device 101 for a portable terminal 100 in accordance with an embodiment of the present invention has a photographing aperture 119 formed in a housing 111 of the portable terminal 100, and an adapter 102, in which a reflector 129a is housed.

The terminal 100 has a display device (not shown) arranged on its front surface. Since the display device has a touch screen function, it is not necessary to provide a separate keypad for inputting characters and figures. The camera device 101 is arranged on a rear surface of the terminal 100, wherein a camera module 113 is provided within the housing 111 of the terminal 100, and the photographing aperture 119 is formed in the housing 111 of the terminal 100 to correspond to the camera module in terms of position. The camera module 113 secures a path for photographing a subject through the photographing aperture 119. However, it is obvious that the photographing aperture should be closed by a window formed from a transparent material, such as glass or acryl.

The adapter 102 is detachably provided to the housing 111 of the terminal 100. The present embodiment exemplifies a configuration of the adapter 102 which is coupled to partly wrap the housing 111 of the terminal 100. More specifically, the adapter 102 includes a body part 121, a guide part 123, and an opening part 125. The body part 121 is coupled to wrap the rear surface, opposite lateral sides, and the top surface of the housing 111 of the terminal, thereby binding the adapter 102 on the housing 111 of the terminal 100. Here, it is not necessary for the body part 121 to wrap all the rear surface, the opposite lateral sides, and the top surface of the housing 111. That is, if the body part 121 is fabricated in a shape capable of binding the adapter 102 to the housing 102, it is not necessary to couple the body part 121 to wrap the three sides of the housing 111 of the terminal 100. For example, the body part 121 may have only a part that is positioned on the rear surface of the housing 111, in which case the body part 121 may be attached to the rear surface of the housing 111 by a magnetic material.

If the body part 121 is coupled to the housing 111, the adapter 102, more particularly, the guide part is positioned at the point corresponding to the camera module 113. As this time, an opening 127 for providing a photographing path is formed through the body part 121 within the guide part 123, which is formed at a side of the guide part 123. In a state in which the body part 121 is coupled to the housing 111, the opening 125 is positioned to be directed toward a lateral direction of the terminal 100.

The reflector 129a is pivotally installed in the guide part 123. In order to 15 pivotally install the guide part 123, a pivot pin 129b may be provided in the guide part 123. The reflector 129a is anchored to the pivot pin 129b, so that the reflector 129a can pivot according to the rotation of the pivot pin 129b. As a result, the inclined angle of the reflector 129a can be selectively adjusted with respect to the photographing direction of the camera module 113.

If the adapter 102 is coupled to the terminal 100, the photographing path of the camera module 113 directed toward the rear surface of the housing 111 is interfered with the guide part 123, and the photographing path can be obtained only through the opening 125 directed toward a lateral side of the terminal 100. At this time, if the guide part 123 is installed to be capable of being rotated about a rotary axis R extending perpendicular to the rear surface of the terminal 100, and more particularly perpendicular to one surface of the body part 121, it is possible to variously secure the photographing direction of the camera module 113. In addition, since the reflector 129a is pivotally installed in the guide part 123, the photograph direction of the camera module can be more variously secured.

As such, the user can use the subject photographing function or the augmented reality function even if the camera module is not directed toward a subject.

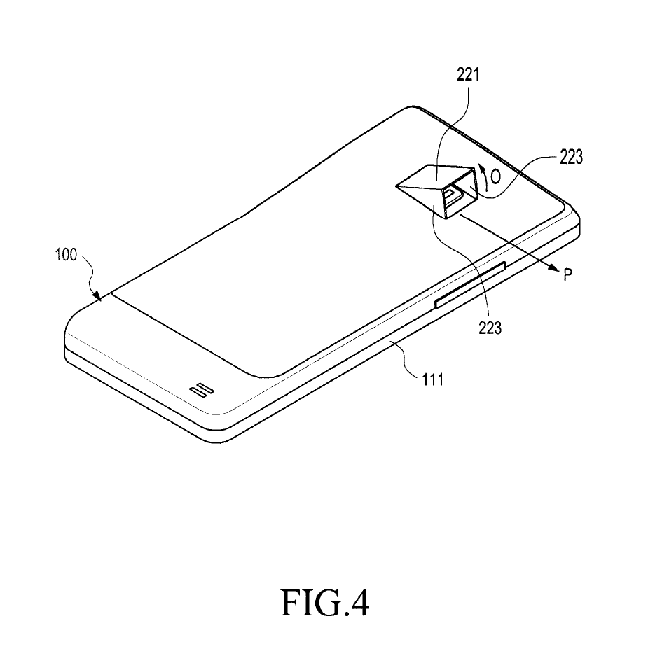

FIG. 4 is a perspective view having a camera device in accordance with another embodiment of the present invention, wherein although the camera module and the photographing aperture are configured identically to those of the previous embodiment, respectively, the adapter is somewhat differently configured as compared to that of the previous embodiment. Therefore, it shall be noted that reference numerals or detailed descriptions may be omitted for the components identical to those of the previous embodiment to avoid redundancy.

In accordance with the present embodiment, the adapter 221 of the camera device has a flat shape, one end edge of which is pivotally coupled to the rear surface of the terminal 100 so that the adapter 221 can come into close contact with the rear surface of the terminal 100. The adapter 221 pivots in the direction indicated by arrow “O” to open the photographing path of the camera module from a closed position. Thus, the adapter 221 is mounted to appear on the terminal 100. Here, if the adapter 221 is opened to 90 degrees from the rear surface, the camera module photographs a subject in its initial installation direction, i.e. in a direction perpendicular to the rear surface of the terminal 100. The adapter 221 can be opened at a various angle to provide different angle of photographing angle with respect to a subject.

The adapter 221 is arranged at a position corresponding to the camera module, so that it can completely close the camera module and the photographing aperture in a state in which it is in close contact with the rear surface of the terminal 100. Although not shown, a reflector is arranged on the inner side of the adapter 221, so that the photographing direction P of the camera module can be adjusted in accordance with the opened angle of the adapter 221. In order to-block light introduced through a path which is different from the photographing path formed by the reflector installed on the inner side of the adapter 221, guide members 223 are preferably arranged on the opposite lateral sides of the adapter 221, respectively. The guide members 223 are received in the terminal 100, and selectively protrude to the outside of the terminal 100 as the adapter 221 pivots.

If the adapter housing a reflector as described above is coupled to a terminal, an image captured by the camera module is captured in a reversed state in terms of top and bottom, left and right, and it is required to correct the image to conform to the subject really viewed by the user's eyes. For this purpose, it would be desirable to provide a program having a function for reversing the top and bottom, left and right of the photographed image in the terminal.

With the above-mentioned construction of the camera device for a portable terminal, a user can conduct photographing in a desired direction in a state in which the user positions the portable terminal so that the user can view the display device of the terminal or can conveniently operate the touch screen function of the display device. As a result, there are advantages in that it is possible to alleviate limitations in using a augmented reality function, which are caused due to surrounding environments, and in that the camera device is convenient to use.

While the invention has been shown and described with reference to certain embodiments thereof, it will be understood by those skilled in the art that various changes in form and details may be made therein without departing from the spirit and scope of the invention as defined by the appended claims.

What is claimed is:

1. A camera device for use in a portable terminal, comprising:
a camera module housed in a housing of the portable terminal;
a photographing aperture formed on one surface of the housing to provide a photographing path of the camera module;
an adapter provided on an outer face of the housing and provide over the photographing aperture, the adapter having a reflector disposed in the adapter to change a photographing direction of the camera module.

2. The camera device as claimed in claim 1, wherein the adapter is detachably provided on the housing.

3. The camera device as claimed in claim 2, wherein the adapter comprises: a body part to wrap at least the opposite lateral sides of the housing and at least one guide part protruding from one surface of the body part to wrap around the housing.

4. The camera device as claimed in claim 3, wherein the guide part is coupled to the body part to be rotatable about a rotary axis extending perpendicular to a surface of the body part.

5. The camera device as claimed in claim 2, wherein the adapter is attachable to the housing using a magnetic material.

6. The camera device as claimed in claim 1, wherein the adapter is provided to retract and extract from the housing.

7. The camera device as claimed in claim 6, wherein the adapter is formed in a flat shape, one end of which is pivotally coupled to the housing to pivot from a closed state from the housing.

8. The camera device as claimed in claim 7, further comprising guide members arranged at the opposite lateral sides of the adapter, respectively, and received within the housing, wherein as the adapter pivots, the guide members selectively protrude to the outside of the terminal.

9. The camera as claimed in claim 1, wherein the reflector is pivotally installed within the adapter so that its inclined angle can be selectively adjusted with respect to the photographing direction of the camera module.

10. A portable terminal, comprising:
a housing having a camera device provided therein;
an adapter provided on an outer face of the housing over the camera device and having a reflector disposed therein, the reflector is rotatable to change a photographing direction of the camera module,
wherein the adaptor is pivotably coupled to the outer face of the housing and selectably pivots from a closed state from the housing.

11. The terminal of claim 10, further comprising a photographing aperture formed on the outer surface of the housing over the camera device to provide a photographing path of the camera module.

12. The terminal of claim 10, wherein the adapter is formed in a flat shape, one end of which is pivotally coupled to the housing to pivot from a closed state from the housing.

13. The terminal of claim 10, wherein the reflector is pivotally installed within the adapter so that its inclined angle can be selectively adjusted with respect to the photographing direction of the camera module.

14. A portable terminal, comprising:
a housing having a camera device provided therein, and
an adapter slidably attached to an outer face of the housing over the camera device, the adapter having a reflector that is rotatable to change a photographing direction of the camera module,

15. The terminal of claim 14, further comprising a photographing aperture formed on the outer surface of the housing over the camera device to provide a photographing path of the camera module.

16. The terminal of claim 14, wherein the adaptor selectably pivots from a closed state from the housing.

17. The terminal of claim 14, wherein the adapter comprises: a body part to wrap at least the opposite lateral sides of the housing and at least one guide part protruding from one surface of the body part to wrap around the housing.

18. The terminal of claim 14, wherein the adapter is formed in a flat shape, one end of which is pivotally coupled to the housing to pivot from a closed state from the housing.

19. The terminal of claim 14, wherein the reflector is pivotally installed within the adapter so that its inclined angle can be selectively adjusted with respect to the photographing direction of the camera module.
